(19) United States
(12) Patent Application Publication
(10) Pub. No.: US 2017/0074638 A1
(43) Pub. Date: Mar. 16, 2017

(54) POLARIZATION-SENSITIVE OCT APPARATUS AND METHOD FOR CONTROLLING THE SAME

(71) Applicant: CANON KABUSHIKI KAISHA, Tokyo (JP)

(72) Inventors: Makoto Fukuhara, Yokohama-shi (JP); Makoto Sato, Tokyo (JP); Nobuhiro Tomatsu, Yokohama-shi (JP); Toshiharu Sumiya, Kawasaki-shi (JP)

(73) Assignee: CANON KABUSHIKI KAISHA, Tokyo (JP)

(21) Appl. No.: 15/120,331

(22) PCT Filed: Feb. 10, 2015
(86) PCT No.: PCT/JP2015/054191

§ 371 Date: Aug. 19, 2016

(30) Foreign Application Priority Data
Feb. 25, 2014 (JP) 2014-034553

(51) Int. Cl. G01B 9/02

(52) U.S. Cl. CPC G01B 9/02011; G01B 9/02091; G01B 2290/70

(57) ABSTRACT

A polarization-sensitive OCT apparatus includes an interference unit configured to split light emitted from a light source into measurement light and reference light and to generate interfered light by causing returning light of the measurement light that has irradiated a subject to interfere with the reference light that has traveled through a reference arm, a splitting unit configured to split the interfered light into different polarization components, a generation unit configured to detect the polarization components split by the splitting unit and to generate a signal, detection units configured to detect respective polarization states of the measurement light in a sample arm, the returning light of the measurement light that has passed through the interference unit, and the reference light that has passed through the interference unit, and polarization control units configured to control the respective polarization states on the basis of the respective polarization states that have been detected.

### TECHNICAL FIELD

The present invention relates to polarization-sensitive optical coherence tomography (PS-OCT) apparatus and method for controlling PS-OCT apparatus. In particular, the present invention relates to a PS-OCT apparatus that is capable of obtaining polarization characteristic information of an eye to be examined and to a method for controlling such a PS-OCT apparatus.

### BACKGROUND ART

Currently, OCT apparatuses that utilize interference of low coherence light are in practical use. OCT apparatuses allow high-resolution tomographic images of subjects to be obtained noninvasively. Thus, especially in ophthalmic field, OCT apparatuses are becoming indispensable in order to obtain tomographic images of fundus of eye to be examined. In addition, OCT apparatuses are employed in fields other than ophthalmic field so as to carry out tomographic observation of skin or to capture tomographic images of walls of digestive organs or circulatory organs by forming OCT apparatuses as endoscopes or catheters.

With ophthalmic OCT apparatuses, an effort is made to obtain, in addition to typical OCT images (also referred to as intensity images) in which images of the shape of fundus tissues are captured, functional OCT images in which images of the optical characteristics or the movements of fundus tissues are captured. In particular, PS-OCT apparatuses are being developed as functional OCT apparatuses that are capable of capturing images of birefringent nerve fiber layer or retina layer having depolarizing properties by obtaining signals with the use of polarization parameters of light, leading to the advancement of research on glaucoma, age-related macular degeneration, and so forth.

A PS-OCT apparatus can form a PS-OCT image by using polarization parameters (retardation and orientation), which are part of the optical characteristics of fundus tissues, and can differentiate among fundus tissues or segment the fundus tissues. Typically, in a PS-OCT apparatus, the optical system includes a wave plate (e.g., a quarter-wave plate or a half-wave plate) and is thus able to change the polarization states of measurement light and reference light as desired in the PS-OCT apparatus. A PS-OCT image is formed by controlling the polarization of light emitted from a light source, by using light that has been modulated to have a predetermined polarization state as measurement light for observing a sample, by splitting interfered light into two linearly polarized light components that are polarized in directions orthogonal to each other, and by detecting the light components.

As a method for controlling the polarization, a method in which reflected or scattered measurement light is detected and the polarization of the measurement light is controlled to a predetermined polarization state by using a wave plate or a polarization controller is being discussed (PIL1). Using such a method makes it possible to correct the polarization state even if the polarization state changes as the OCT apparatus is being used.

In addition, a method in which the polarization state is modulated by using an electro-optical modulator (EOM) is also being discussed (PTL2). In this method, a single site is irradiated with a plurality of light rays having different polarization states, and thus a PS-OCT image can be generated on the basis of the polarization information obtained in the plurality of polarization states, which makes it possible to obtain a more accurate PS-OCT image. In addition, a polarization controller for controlling the polarization state is disposed in each of a sample arm, a reference arm, and an optical path through which interfered light travels toward a detector (hereinafter, referred to as an interfered light optical path), and thus the polarization state can be controlled independently in each of the optical paths.

In existing PS-OCT apparatuses, polarization-maintaining (PM) fibers, wave plates, or EOMs are used in order to control the polarization.

PTL1 discloses a PS-OCT apparatus in which the measurement light is reflected or scattered so as to detect the polarization state of the measurement light and the polarization is corrected by using a wave plate or a polarization controller so that the measurement light has a predetermined polarization state. This method, however, is limited to controlling the polarization of only the measurement light, and this configuration does not allow the polarization to be controlled in the reference arm.

PTL2 discloses a PS-OCT apparatus that includes an EOM and a plurality of polarization controllers for controlling the polarization. PTL2, however, does not disclose how each of the polarization controllers is controlled, and the polarization state cannot be corrected, for example, in a case in which the polarization state changes as the PS-OCT apparatus is being used.

### CITATION LIST

### Patent Literature

PTL1 Japanese Patent Laid-Open No. 2013-165961

PTL2 Japanese Patent Laid-Open No. 2007-298461

### SUMMARY OF INVENTION

The present invention is directed to providing a PS-OCT apparatus that is capable of detecting a polarization state in each optical path and controlling the polarization in each optical path on the basis of detected polarization information.

According to one aspect of the present invention, a polarization-sensitive OCT apparatus includes an interference unit configured to split light emitted from a light source into measurement light and reference light and to generate interfered light by causing returning light of the measurement light that has irradiated a subject to interfere with the reference light that has traveled through a reference arm, a splitting unit configured to split the interfered light into different polarization components, a generation unit configured to detect the polarization components split by the splitting unit and to generate a signal, detection units configured to detect respective polarization states of the measurement light in a sample arm, the returning light of the measurement light that has passed through the interference unit, and the reference light that has passed through the interference unit, and polarization control units configured to control the respective polarization states of the measurement light, the returning light of the measurement light, and the reference light on the basis of the respective polarization states that have been detected by the detection units.

Further features of the present invention will become apparent from the following description of exemplary embodiments with reference to the attached drawings.

### BRIEF DESCRIPTION OF DRAWINGS

FIG. 1 is a schematic diagram illustrating an overall configuration of a spectral-domain (SD) PS-OCT apparatus according to a first exemplary embodiment.

FIG. 2 is a flowchart for describing a method for controlling a polarization state in the SD PS-OCT apparatus according to the first exemplary embodiment.

FIG. 3 is a schematic diagram illustrating an overall configuration of a swept-source (SS) PS-OCT apparatus according to a second exemplary embodiment.

FIG. 4 is a flowchart for describing a method for controlling a polarization state in the SS PS-OCT apparatus according to the second exemplary embodiment.

### DESCRIPTION OF EMBODIMENTS

A first exemplary embodiment of the present invention will be described in detail with reference to the drawings.

### First Exemplary Embodiment

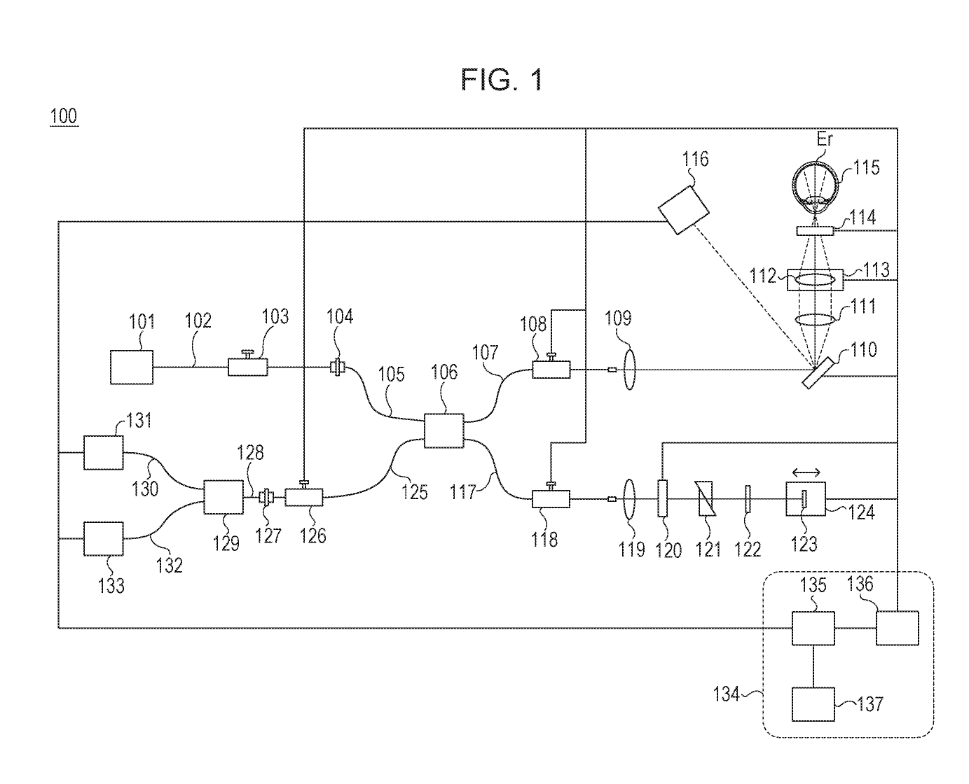

In the present exemplary embodiment, a configuration of a PS-OCT apparatus will be described with reference to FIG. 1.

### Overall Configuration of Apparatus

FIG. 1 is a schematic diagram illustrating an overall configuration of the PS-OCT apparatus according to the present exemplary embodiment. In the present exemplary embodiment, a configuration of an SD PS-OCT apparatus will be described.

### Configuration of SD PS-OCT Apparatus 100

A configuration of an SD PS-OCT apparatus 100 will be described.

A light source 101 is a superluminescent diode (SLD) light source, which is a low coherence light source, and emits light, for example, at a central wavelength of 850 nm and with a bandwidth of 50 nm. Although an SLD light source is used as the light source 101, any light sources, such as an amplified spontaneous emission (ASE) light source, that is capable of emitting low coherence light may be used.

Light emitted from the light source 101 is guided to a beam splitter 106 via a single-mode (SM) fiber 102, a polarization controller 103, a connector 104, and an SM fiber 105, and is split into measurement light (also referred to as OCT measurement light) and reference light (also referred to reference light corresponding to OCT measurement light). The split ratio of the beam splitter 106 is 90:10 (reference light:measurement light). It is to be noted that the split ratio is not limited to these values, and can take other values. The beam splitter 106 is connected to SM fibers 105, 107, 117, and 125 in the present exemplary embodiment. An advantage of connecting a beam splitter to SM fibers lies in that the polarization can be controlled in-line with ease by using a polarization controller. The aforementioned SM fibers 105, 107, 117, and 125, however, may be PM fibers. In a case in which the beam splitter 106 is connected to PM fibers, polarization controllers 108, 118, and 126 do not need to be provided. Alternatively, wave plates may be provided in a sample arm and in a reference arm. For example, in place of the polarization controller 108, a quarter-wave plate may be disposed between a collimator 109 and a galvanoscanner 110, and in place of the polarization controller 118, a quarter-wave plate may be disposed between a collimator 119 and a shutter 120.

The polarization controller 103 controls the polarization of light emitted from the light source 101 to a predetermined polarization state. The polarization controller 103, for example, is a bulk polarization controller in which light is emitted to a space from a fiber and the polarization of the light is controlled by using a half-wave plate and a quarter-wave plate, a paddle fiber polarization controller in which paddles are formed by winding a fiber in a coil form and the polarization is controlled by rotating each paddle, and an in-line fiber polarization controller in which the polarization is controlled by pressurizing and rotating a fiber.

In the present exemplary embodiment, light from the light source 101 is controlled to be linearly polarized by the polarization controller 103. It is to be noted that, although the description is omitted in the present exemplary embodiment, if the degree of polarization of the light source 101 is not high, a polarizer may be disposed between the polarization controller 103 and the connector 104 so as to increase the degree of polarization of the light emitted from the light source 101. In this case, the quantity of light passing through the polarizer may be controlled by controlling the polarization controller 103. In addition, in place of disposing the polarization controller 103, only a polarizer may be disposed on the SM fiber 102. In this case, the polarization state of the light emitted from the light source 101 does not need to be controlled, and only the degree of polarization of the light can be increased. However, the quantity of light guided to an interferometer may be reduced depending on the polarization state of the light, and thus it is desirable to check whether a sufficient quantity of light is obtained. In one method for checking the quantity of light, for example, light that has passed through the polarizer and is emitted from the collimator 119 disposed in the reference arm or light that has passed through the polarizer and reaches a position corresponding to the pupil position in the sample arm may be measured with a power monitor, and a determination may be made as to whether the obtained result is equal to or greater than a preset quantity of light. In an alternative method, a determination is made as to whether a sufficient quantity of light is detected by a detector 131 or 133.

The split measurement light is emitted through the SM fiber 107 serving as a measurement light side fiber, and is collimated by the collimator 109. In addition, the polarization controller 108 is disposed on the SM fiber 107 and can change the polarization state of the emitted measurement light as desired. In the present exemplary embodiment, the polarization controller 108 is controlled such that circularly polarized measurement light is incident on an eye 115 to be examined.

In a case in which the polarization state of light incident on the eye 115 to be examined, or a subject, differs from the polarization state of light incident on a measurement light detector 116, if the light is controlled to be circularly polarized when the light is incident on the eye 115 to be examined, the light becomes elliptically polarized when the light is incident on the measurement light detector 116. The state of the elliptical polarization to be detected by the measurement light detector 116 in a case in which the light is circularly polarized when being incident on the eye 115 to be examined is uniquely determined, and thus the polarization controller 108 is controlled such that the light is circularly polarized when the light is incident on the eye 115 to be examined while the elliptically polarized light is detected by the measurement light detector 116. Here, it is needless to say that the measurement light detector 116 and the eye 115 to be examined are disposed so as to be conjugate to each other. Aside from using a detector, such as a polarization measuring device, as the measurement light detector 116, the polarization state may be determined by using an optical power meter and a polarizer, a wave plate, or the like.

Alternatively, a polarization controller or a wave plate may be used so that the polarization state of the measurement light to be detected by the measurement light detector 116 becomes identical to the polarization state of the measurement light at the position of the eye 115 to be examined. For example, in a case in which the measurement light is to be made incident on the measurement light detector 116 by varying the angle of the galvanoscanner 110, a wave plate may be disposed between the galvanoscanner 110 and the measurement light detector 116 in such a manner that the polarization state to be detected by the measurement light detector 116 becomes identical to the polarization state at the position of the eye 115 to be examined.

When an image is actually to be captured, the collimated measurement light is incident on the eye 115 to be examined via the galvanoscanner 110, which scans a fundus Er of the eye 115 to be examined with the measurement light, a scan lens 111, and an objective lens 112. Here, although the galvanoscanner 110 is illustrated as a single mirror, the galvanoscanner 110 may be formed by two galvanoscanners so as to carry out a raster scan of the fundus Er of the eye 115 to be examined. In addition, the objective lens 112 is fixed to a stage 113, and as the stage 113 is moved in the direction of the optical axis, the diopter of the eye 115 to be examined can be adjusted. The galvanoscanner 110 and the stage 113 are controlled by a driving control unit 136, and the galvanoscanner 110 can scan the fundus Er of the eye 115 to be examined within a predetermined range (also referred to as a tomographic image obtaining range, a tomographic image obtaining position, or a measurement light irradiation position) with the measurement light.

The measurement light is made to be incident on the eye 115 to be examined via the objective lens 112 disposed on the stage 113 and is focused on the fundus Er. The measurement light that has irradiated the fundus Er is reflected or scattered by each retina layer and returns to the beam splitter 106 through the above-described optical path.

Meanwhile, the reference light that has been split by the beam splitter 106 is emitted through the SM fiber 117 serving as a reference light side fiber, and is collimated by the collimator 119. The polarization controller 118 is disposed on the SM fiber 117 and can change the polarization state of the emitted reference light as desired. In the present exemplary embodiment, the driving control unit 136 controls the polarization controller 118 in such a manner that the reference light that has been reflected by a mirror 123 is incident on a polarizing beam splitter 129 as linearly polarized light that is polarized at an angle of 45° relative to each of the two polarization axes that are orthogonal to each other. The reference light passes through a dispersion compensation glass 121 and an ND filter 122 and is reflected by the mirror 123 disposed on a coherence gate stage 124, and the reflected reference light returns to the beam splitter 106. The coherence gate stage 124 is controlled by the driving control unit 136 so as to accommodate to the differences in the axial length among the eyes of subjects.

The measurement light and the reference light that have returned to the beam splitter 106 are combined to result in interfered light, and the resulting interfered light is incident on the polarization beam splitter 129 via the SM fiber 125 serving as a detection light side fiber, the polarization controller 126, a connector 127, and an SM fiber 128. The interfered light is split into a vertical polarization component (hereinafter, V polarization component) and a horizontal polarization component (hereinafter, H polarization component) by the polarization beam splitter 129 in accordance with the two polarization axes that are orthogonal to each other. The V polarization component of the split interfered light is incident on the detector 131 via an SM fiber 130. Meanwhile, the H polarization component of the interfered light is incident on the detector 133 via an SM fiber 132. The light received by each of the detectors 131 and 133 is outputted to a signal processing unit 135 in the form of an electric signal in accordance with the intensity of the light.

It is to be noted that, as the reference light is linearly polarized at an angle of 45° in the present exemplary embodiment, the reference light is split into the V polarization component and the H polarization component in the equal quantity. In addition, as the measurement light is circularly polarized in the present exemplary embodiment, data can be obtained simultaneously regardless of the directions of the cells and the fibers of the fundus Er of the eye 115 to be examined. As a result, data can be obtained at once in the entire polarization directions. Thus, it is not necessary to capture images of a single site in different polarization directions, and data can be obtained through a single instance of image capturing.

In addition, in the present exemplary embodiment, a movable mirror 114 for reflecting the measurement light is disposed in the optical path of the measurement light prior to being incident on the eye 115 to be examined. The mirror 114 is controlled by the driving control unit 136, and has a function of preventing the measurement light from being incident on the eye 115 to be examined when the polarization controller 126 is controlled by reflecting the measurement light and returning the measurement light to the beam splitter 106. Therefore, the angle of the mirror 114 is adjusted such that, in a state in which the mirror 114 is disposed in the sample arm, the light that has been emitted through the SM fiber 107 is guided to the mirror 114 via the collimator 109, the galvanoscanner 110, the scan lens 111, and the objective lens 112 and is reflected by the mirror 114, and such that the reflected light returns to the beam splitter 106. It is to be noted that, although a mirror is disposed in the present exemplary embodiment, any reflector that can reflect the measurement light can be employed.

In addition, in the present exemplary embodiment, the shutter 120 for blocking the reference light is disposed next to the collimator 119. The shutter 120 is controlled by the driving control unit 136, and prevents the reference light from returning to the beam splitter 106 when the driving control unit 136 controls the polarization controller 126.

### Control Unit 134

A control unit 134 for controlling the SD PS-OCT apparatus 100 as a whole will be described.

The control unit 134 includes the signal processing unit 135, the driving control unit 136, and a display unit 137.

The signal processing unit 135 generates an image, analyzes the generated image, and generates visualized information of the result of the analysis on the basis of the signals outputted from the detectors 131 and 133. The methods for generating and analyzing the image are well-known, and thus descriptions thereof will be omitted herein.

The image generated by the signal processing unit 135 or the result of the analysis is displayed on a display screen of the display unit 137 (e.g., liquid crystal display or the like). The image data generated by the signal processing unit 135 may be transmitted to the display unit 137 through a cable or wirelessly.

Although the display unit 137 is included in the control unit 134, the present invention is not limited to such a configuration, and the display unit 137 may be provided separately from the control unit 134. In that case, a touch panel function may be provided in the display unit 137, and a user may be able to operate the touch panel so as to change the display position of the image, to enlarge or reduce the image, or to modify the displayed image.

In addition, the signal processing unit 135 receives polarization information outputted from the measurement light detector 116 or the detectors 131 and 133, and transmits information necessary for controlling the polarization to the driving control unit 136.

The driving control unit 136 drives the galvanoscanner 110 and the stage 113 as described above when an image of the eye 115 to be examined is to be captured. In addition, the driving control unit 136 drives the galvanoscanner 110, the mirror 114, the shutter 120, and the polarization controllers 108, 118, and 126 in accordance with the information received from the signal processing unit 135.

### Processing Operation

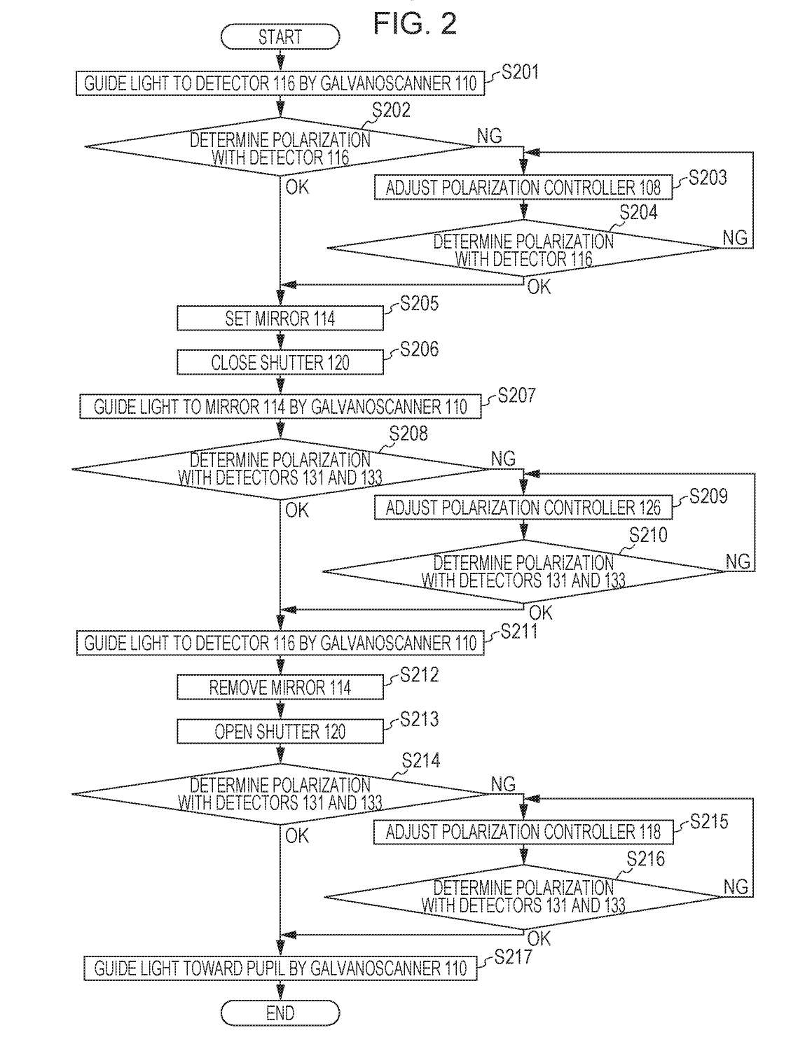

Subsequently, a process of controlling the polarization state by the polarization controllers 108, 118, and 126 will be described with reference to the flowchart illustrated in FIG. 2, and this process is a characteristic processing operation according to the present exemplary embodiment.

First, a correction starts when, for example, an examiner presses a correction start button (not illustrated) displayed on the display unit 137 or presses a correction start button physically provided on the SD PS-OCT apparatus 100. Alternatively, a timing of carrying out a correction may be preset as desired. For example, a correction may be set to be carried out when the SD PS-OCT apparatus 100 is started or immediately before the measurement starts. Alternatively, the temperature of the SD PS-OCT apparatus 100 may be monitored, and a correction may be set to be carried out when a variation in the temperature is large.

After the correction starts, in step S201, the driving control unit 136 controls the angle of the galvanoscanner 110 so as to cause the measurement light to be incident on the measurement light detector 116. In step S202, the measurement light is measured and determined whether it is circularly polarized. If the measurement light is not circularly polarized (NG in step S202), the processing proceeds to step S203, and the driving control unit 136 controls the polarization controller 108 so as to control the polarization state of the measurement light to be detected by the measurement light detector 116. In step S204, the polarization state of the controlled measurement light is determined, and if the measurement light is circularly polarized (OK in step S204), the processing proceeds to step S205; otherwise, the processing returns to step S203. Here, an example of the criteria for determining the polarization state is based on the ellipticity of the measurement light or the signal intensity of the measurement light that has passed through a polarizer.

Thereafter, the polarization controller 126 is controlled. The polarization controller 126 is controlled by using only the measurement light. In step S205, the driving control unit 136 drives the mirror 114 so that the measurement light is reflected by the mirror 114 and the reflected measurement light returns to the beam splitter 106. Then, in step S206, the shutter 120 is closed so that the reference light does not return to the beam splitter 106. In step S207, the angle of the galvanoscanner 110 is controlled so that the measurement light is reflected by the mirror 114 and the reflected measurement light returns to the beam splitter 106. Since the light to be incident on the mirror 114 is controlled to be circularly polarized, the measurement light that returns to the beam splitter 106 again becomes linearly polarized. The measurement light incident on the beam splitter 106 is then guided to the polarization beam splitter 129 via the SM fiber 125, the polarization controller 126, the connector 127, and the SM fiber 128. The measurement light is split into two polarization components, namely, the V polarization component and the H polarization component by the polarization beam splitter 129. In step S208, the signal processing unit 135 determines whether the light is detected only with one of the detectors 131 and 133. If the light is not detected with only one of the detectors 131 and 133 (NG in step S208), in step S209, the driving control unit 136 controls the polarization controller 126 so that the light is detected only with one of the detectors 131 and 133. Then, in step S210, as in step S208, the polarization state is determined, and if the determination result is NG, the processing returns to step S209. Meanwhile, if the determination result is OK, the processing proceeds to step S211. Here, an example of the criteria for determining that a signal is detected only with one of the detectors 131 and 133 is based on a case in which the ratio between the signal intensities of the two detectors is the highest.

Lastly, the polarization controller 118 is controlled. The polarization controller 118 is controlled by using only the reference light signal.

In step S211, the driving control unit 136 drives the galvanoscanner 110 so that the measurement light does not return to the beam splitter 106 and causes the measurement light to be incident on the measurement light detector 116. In step S212, the mirror 114 is removed. Here, although the measurement light is made to be incident on the measurement light detector 116 in the present exemplary embodiment, the measurement light does not have to be made to be incident on the measurement light detector 116 as long as the measurement light does not return to the beam splitter 106. Subsequently, in step S213, the shutter 120 is opened, and the block on the reference light is released. The reference light travels through the SM fiber 117, the polarization controller 118, the collimator 119, the dispersion compensation glass 121, and the ND filter 122, and is reflected by the mirror 123. The reflected light is then guided to the beam splitter 106. The reference light to be emitted from the SM fiber 117 has been controlled to be linearly polarized by the polarization controller 103. Therefore, it is obvious that, even in a case in which the reference light has been made to be elliptically polarized or circularly polarized by the polarization controller 118, as the reference light is reflected by the mirror 123 and passes through the polarization controller 118 again, the reference light becomes linearly polarized. In step S214, the signal processing unit 135 determines whether the signal intensities of the light components detected by the respective detectors 131 and 133 are substantially equal to each other. If the signal intensities are not substantially equal to each other (NG in step S214), in step S215, the driving control unit 136 controls the polarization controller 118 so that the signal intensities become substantially equal to each other. Then, in step S216, as in step S214, the polarization state is determined, and if the determination result is NG, the processing returns to step S215. Meanwhile, if the determination result is OK, the processing proceeds to step S217. Here, an example of the criteria for determining that the signal intensities of the light components detected by the two detectors 131 and 133 are substantially equal to each other is based on the ratio of the signal intensities obtained from the two detectors 131 and 133. The reference light to be guided to the polarization beam splitter 129 in the end can be controlled to be linearly polarized light in which the ratio of the V polarization component and the H polarization component is 1:1, or in other words, linearly polarized light that is polarized at an angle of 45° relative to each of the two polarization axes that are orthogonal to each other. Then in step S217, the galvanoscanner 110 is driven so that the measurement light is directed in a direction in which the measurement light is incident on the eye 115 to be examined at the time of the measurement, and the measurement is continued.

According to the configuration and the processing operation described thus far, the polarization state is controlled as appropriate by the polarization controllers provided in the respective optical paths in the interferometer in accordance with the detected polarization states. Therefore, even in a case in which the polarization state changes due to heat produced while the SD PS-OCT apparatus 100 is being used, the polarization state can be corrected.

Although a polarizer is not disposed between the SM fiber 102 and the SM fiber 105 in the present exemplary embodiment, a polarizer may be disposed between the SM fiber 102 and the SM fiber 105 depending on the degree of polarization of the light source 101. In that case, the connector 104 is disconnected from the SM fibers 102 and 105, and the SM fiber 102 is connected to an input terminal of the polarizer. Meanwhile, an output terminal of the polarizer is connected to the SM fiber 105, and thus the aforementioned configuration can be achieved. In addition, although a method for connecting the SM fibers 102 and 105 directly to the polarizer has been described above, the present exemplary embodiment is not limited to such a configuration. In a case in which a component formed by integrating optical fibers and a polarizer is to be added, the SM fiber 102 is disconnected from the connector 104, and the optical fiber at an input side of the polarizer is connected to the SM fiber 102 by using another connector. In addition, the optical fiber at an output side of the polarizer is connected to the connector 104, and thus the polarizer can be added.

In addition, although the SD PS-OCT apparatus 100 in which the polarization controllers 108, 118, and 126 are controlled on the basis of the result of detecting the polarization state with the measurement light detector 116 or the detectors 131 and 133 has been described in the present exemplary embodiment, such control may be carried out semi-automatically. Specifically, the result of detecting the polarization state with the measurement light detector 116 or the detectors 131 and 133 may be displayed on the display unit 137, and the user may control each of the polarization controllers 108, 118, and 126 as appropriate in accordance with the displayed result.

In addition, it is obvious that the present invention can be applied not only to the case in which a PS-OCT is formed by fibers but also in a case in which a PS-OCT is formed by a space optical system.

As described thus far, by capturing an image of an eye to be examined after each of the polarization controllers is controlled, an accurate PS-OCT image can be captured.

### Second Embodiment

While an example of SD-OCT has been illustrated in the first exemplary embodiment, the present invention is not limited thereto, and a PS-OCT image can also be obtained in a similar manner through a swept-source (SS) OCT that uses an SS-light source. In addition, while the SD PS-OCT apparatus 100 is formed by a Michelson interferometer in the first exemplary embodiment, a similar effect can be obtained by a PS-OCT apparatus formed by a Mach-Zehnder interferometer.

In the present exemplary embodiment, as an example of PS-OCT having a different configuration, a configuration and a method for controlling the polarization in a case in which an SS PS-OCT apparatus is formed by a Mach-Zehnder interferometer will be described. A basic configuration of SS-OCT is well-known, and thus detailed description thereof will be omitted.

### Configuration of SS PS-OCT Apparatus 300

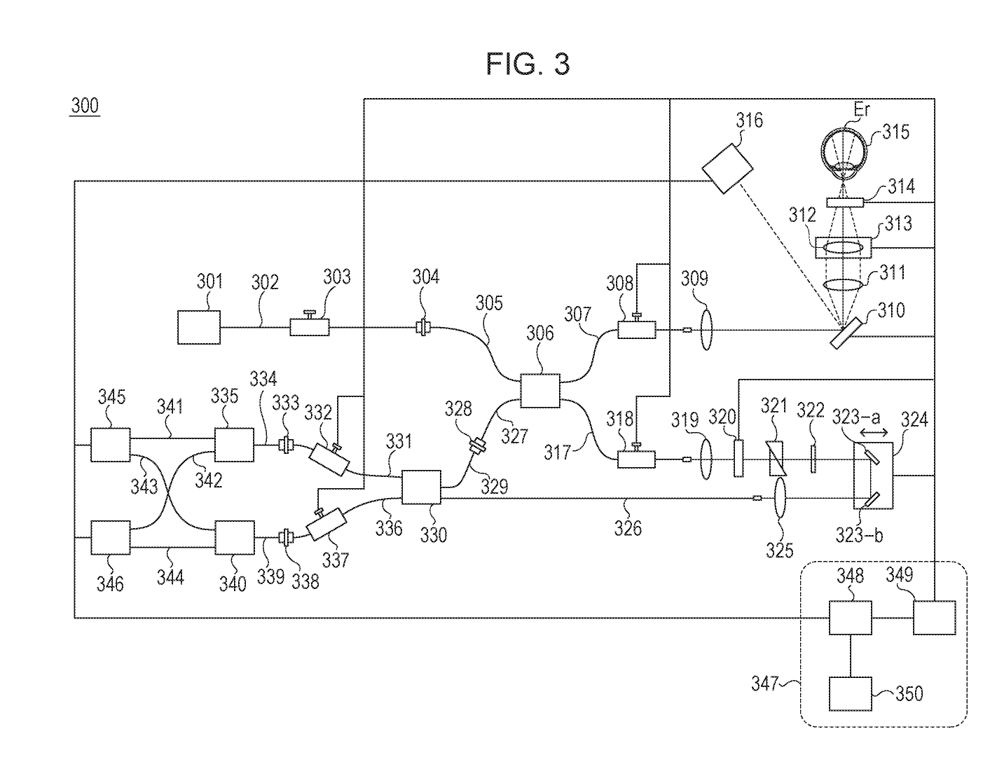

A configuration of an SS PS-OCT apparatus 300 will be described with reference to FIG. 3. It is to be noted that detailed descriptions of configurations that are similar to those of the first exemplary embodiment will be omitted.

A light source 301 is formed by using an SS-light source of which the oscillation wavelength of the light varies periodically, and in the present exemplary embodiment, for example, the light source 301 emits light at a central wavelength of 1040 nm and with a bandwidth of 100 nm.

Light emitted from the light source 301 is guided to a beam splitter 306 via an SM fiber 302, a polarization controller 303, a connector 304, and an SM fiber 305, and is split into measurement light and reference light. The split ratio of the beam splitter 306 is 90:10 (reference light:measurement light). It is to be noted that the split ratio is not limited to these values, and can take other values. The beam splitter 306 is connected to SM fibers 305, 307, 317, and 327 in the present exemplary embodiment. Although a beam splitter 330 is connected to SM fibers 326, 329, 331, and 336, the aforementioned SM fibers may instead be PM fibers. In a case in which the beam splitters 306 and 330 are connected to PM fibers, polarization controllers 308, 318, 332, and 337 do not need to be provided. Alternatively, wave plates may be disposed in the sample arm and in the reference arm. For example, in place of the polarization controller 308, a wave plate may be disposed between a collimator 309 and a galvanoscanner 310, and in place of the polarization controller 318, a wave plate may be disposed between a collimator 319 and a shutter 320.

The polarization controller 303 can change the polarization of the light emitted from the light source 301 to a predetermined polarization state. In the present exemplary embodiment, the light from the light source 301 is controlled to be linearly polarized by the polarization controller 303. It is to be noted that, although the description is omitted in the present exemplary embodiment, when the degree of polarization of the light source 301 is not high, a polarizer may be disposed between the polarization controller 303 and the connector 304 so as to increase the degree of polarization of the light emitted from the light source 301. In that case, the quantity of light passing through the polarizer can be controlled by controlling the polarization controller 303. In addition, in place of disposing the polarization controller 303, only a polarizer may be disposed on the SM fiber 302. In this case, the polarization state of the light emitted from the light source 301 does not need to be controlled, and only the degree of polarization of the light can be increased. However, the quantity of light guided to an interferometer may be reduced depending on the polarization state of the light, and thus it is necessary to determine whether a sufficient quantity of light is obtained.

The split measurement light is emitted through the SM fiber 307 and is collimated by the collimator 309. In addition, the polarization controller 308 is disposed on the SM fiber 307 and can change the polarization state of the emitted measurement light as desired. In the present exemplary embodiment, the polarization controller 308 is controlled such that circularly polarized light is incident on an eye 315 to be examined.

In a case in which the polarization state of light incident on the eye 315 to be examined, or a subject, differs from the polarization state of light incident on a measurement light detector 316, if the light is controlled to be circularly polarized when the light is incident on the eye 315 to be examined, the light becomes elliptically polarized when the light is incident on the measurement light detector 316. The state of the elliptical polarization to be detected by the measurement light detector 316 as the light is circularly polarized when being incident on the eye 315 to be examined is uniquely determined, and thus the polarization controller 308 is controlled such that the light is circularly polarized when the light is incident on the eye 315 to be examined while the elliptically polarized light is detected by the measurement light detector 316.

It is to be noted that aside from using a detector, such as a polarization measuring device, as the measurement light detector 316, the polarization state may be determined by using an optical power meter and a polarizer, a wave plate, or the like.

Alternatively, a polarization controller or a wave plate may be used so that the polarization state of the measurement light to be detected by the measurement light detector 316 becomes identical to the polarization state of the measurement light at the position of the eye 315 to be examined. For example, in a case in which the measurement light is to be made incident on the measurement light detector 316 by varying the angle of the galvanoscanner 310, a wave plate may be disposed between the galvanoscanner 310 and the measurement light detector 316 in such a manner that the polarization state to be detected by the measurement light detector 316 becomes identical to the polarization state at the position of the eye 315 to be examined.

The collimated measurement light is incident on the eye 315 to be examined via the galvanoscanner 310, which scans the fundus Er of the eye 315 to be examined with the measurement light, a scan lens 311, and an objective lens 312. Here, although the galvanoscanner 310 is illustrated as a single mirror, the galvanoscanner 310 may be formed by two galvanoscanners so as to carry out a raster scan of the fundus Er of the eye 315 to be examined. In addition, the objective lens 312 is fixed to a stage 313, and as the stage 313 is moved in the direction of the optical axis, the diopter of the eye 315 to be examined can be adjusted. The galvanoscanner 310 and the stage 313 are controlled by a driving control unit 349, and the galvanoscanner 310 can scan the fundus Er of the eye 315 to be examined within a predetermined range (also referred to as a tomographic image obtaining range, a tomographic image obtaining position, or a measurement light irradiation position) with the measurement light.

The measurement light is made to be incident on the eye 315 to be examined through the objective lens 312 disposed on the stage 313 and is focused on the fundus Er. The measurement light that has irradiated the fundus Er is reflected or scattered by each retina layer and returns to the beam splitter 306 through the above-described optical path.

The reference light that has been split by the beam splitter 306 is emitted through the SM fiber 317 and is collimated by the collimator 319. The polarization controller 318 is disposed on the SM fiber 317 and can change the polarization state of the emitted reference light as desired. In the present exemplary embodiment, the polarization controller 318 controls the polarization state of the reference light that is to be reflected by mirrors 323-a and 323-b and that is to be incident on polarization beam splitters 335 and 340 to become linearly polarized at an angle of 45° relative to each of the two polarization axes that are orthogonal to each other.

The reference light travels through a dispersion compensation glass 321 and an ND filter 322 and is then reflected by the mirrors 323-a and 323-b disposed on a coherence gate stage 324. The reflected reference light is incident on the beam splitter 330 via a collimator 325 and the SM fiber 326.

At the beam splitter 330, the returning light of the measurement light that is incident on the beam splitter 330 via the beam splitter 306, the SM fiber 327, a connector 328, and the SM fiber 329 is combined with the reference light that is incident on the beam splitter 330 via the SM fiber 326, resulting in interfered light, and the resulting interfered light is split into two components by the beam splitter 330. The split components of the interfered light have phases that are inverted relative to each other (hereinafter, referred to as a positive component and a negative component). The split positive interfered light is then guided to the polarization beam splitter 335 via the SM fiber 331, the polarization controller 332, a connector 333, and an SM fiber 334. Here, the interfered light is split along the two polarization axes that are orthogonal to each other, and is split into a positive H polarization component and a positive V polarization component. In a similar manner, the negative interfered light is guided to the polarization beam splitter 340 via the SM fiber 336, the polarization controller 337, a connector 338, and an SM fiber 339, and is then split into a negative H polarization component and a negative V polarization component.

The positive H polarization component generated at the polarization beam splitter 335 and the negative H polarization component generated at the polarization beam splitter 340 are guided to a detector 346 via SM fibers 342 and 344, respectively, and are detected by the detector 346. Meanwhile, the positive V polarization component generated at the polarization beam splitter 335 and the negative V polarization component generated at the polarization beam splitter 340 are guided to a detector 345 via SM fibers 341 and 343, respectively.

Interference signals detected by the detectors 345 and 346 are converted to electric signals, and the electric signals are then transmitted to a signal processing unit 348. The signal processing unit 348 generates a PS-OCT image on the basis of the information from each of the detectors 345 and 346. The method for generating a PS-OCT image is well-known, and thus description thereof will be omitted.

It is to be noted that as the reference light is linearly polarized at an angle of 45° in the present exemplary embodiment, the reference light is split into the V polarization component and the H polarization component in the equal quantity. In addition, the measurement light is circularly polarized in the present exemplary embodiment, and thus data can be obtained simultaneously regardless of the directions of the cells and the fibers of the fundus Er of the eye 315 to be examined. As a result, data can be obtained at once in the entire polarization directions. Thus, it is not necessary to capture images of a single site in different polarization directions, and data can be obtained through a single instance of image capturing.

In addition, in the present exemplary embodiment, a movable mirror 314 for reflecting the measurement light is disposed in the optical path of the measurement light prior to being incident on the eye 315 to be examined. The mirror 314 is controlled by the driving control unit 349, and has a function of preventing the measurement light from being incident on the eye 315 to be examined when the polarization controllers 332 and 337 are controlled by reflecting the measurement light and returning the measurement light to the beam splitter 306. Therefore, the angle of the mirror 314 is adjusted such that, in a state in which the mirror 314 is disposed in the sample arm, the light that has been emitted through the SM fiber 307 is guided to the mirror 314 via the collimator 309, the galvanoscanner 310, the scan lens 311, and the objective lens 312 and is reflected by the mirror 314, and such that the reflected light returns to the beam splitter 306. It is to be noted that, although a mirror is disposed in the present exemplary embodiment, any reflector that can reflect the measurement light can be employed.

In addition, in the present exemplary embodiment, the shutter 320 for blocking the reference light is disposed next to the collimator 319. The shutter 320 is controlled by the driving control unit 349, and the shutter 320 prevents the reference light from being incident on the beam splitter 330 when the driving control unit 349 controls the polarization controllers 332 and 337.

### Control Unit 347

A control unit 347 for controlling the SS PS-OCT apparatus 300 as a whole will be described.

The control unit 347 includes the signal processing unit 348, the driving control unit 349, and a display unit 350.

The signal processing unit 348 generates an image, analyzes the generated image, and generates visualized information of the result of the analysis on the basis of the signals outputted from the detectors 345 and 346. The methods for generating and analyzing the image are well-known, and thus descriptions thereof will be omitted.

The image generated by the signal processing unit 348 or the result of the analysis is displayed on a display screen of the display unit 350 (e.g., liquid crystal display or the like). The image data generated by the signal processing unit 348 may be transmitted to the display unit 350 through a cable or wirelessly.

Although the display unit 350 is included in the control unit 347, the present invention is not limited to such a configuration, and the display unit 350 may be provided separately from the control unit 347. In that case, a touch panel function may be provided in the display unit 350, and a user may be able to operate the touch panel so as to change the display position of the image, to enlarge or reduce the image, or to modify the displayed image.

In addition, the signal processing unit 348 receives polarization information outputted from the measurement light detector 316 or the detectors 345 and 346, and transmits information necessary for controlling the polarization to the driving control unit 349.

The driving control unit 349 drives the galvanoscanner 310 and the stage 313 as described above when an image of the eye 315 to be examined is to be captured. In addition, the driving control unit 349 drives the galvanoscanner 310, the mirror 314, the shutter 320, and the polarization controllers 308, 318, 332, and 337 in accordance with the information received from the signal processing unit 348.

### Processing Operation

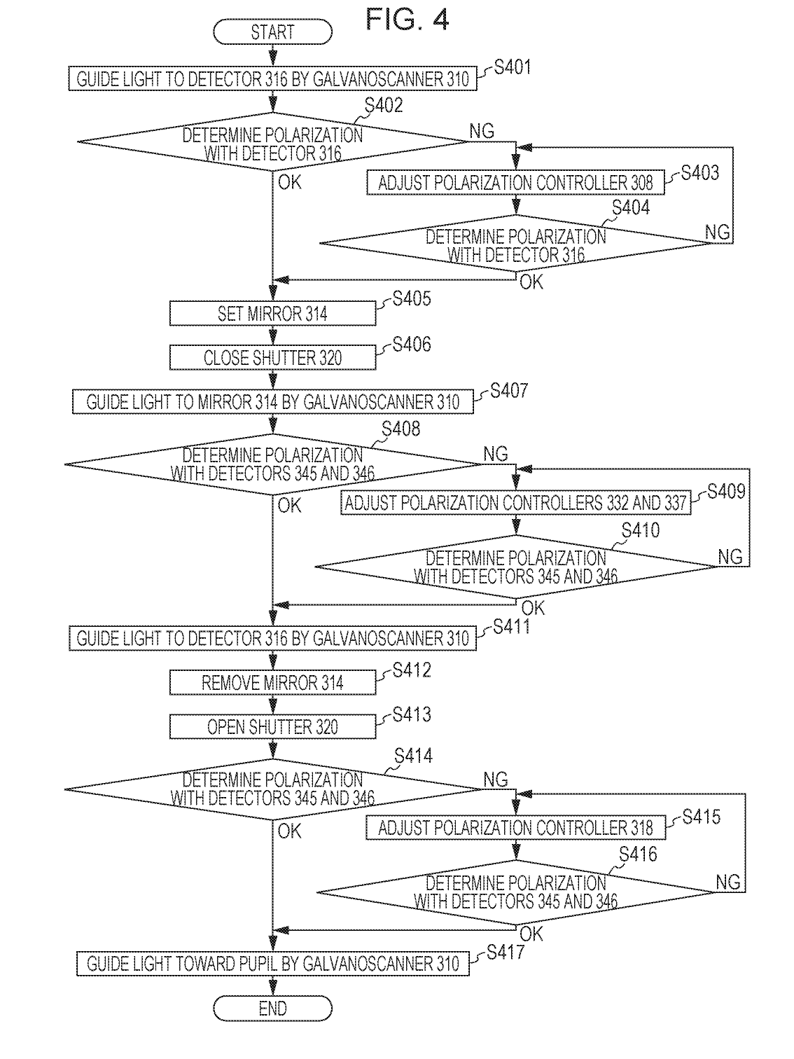

In the present exemplary embodiment, a process of controlling the polarization in a system by controlling the polarization controllers 308, 318, 332, and 337 will be described with reference to FIGS. 3 and 4.

First, a correction starts when, for example, an examiner presses a correction start button (not illustrated) displayed on the display unit 350 or presses a correction start button physically provided on the SS PS-OCT apparatus 300.

After the correction starts, in step S401, the driving control unit 349 controls the angle of the galvanoscanner 310 so as to cause the measurement light to be incident on the measurement light detector 316. In step S402, it is determined whether the measurement light is circularly polarized. If the measurement light detected by the measurement light detector 316 is not circularly polarized (NG in step S402), the processing proceeds to step S403, and the driving control unit 349 controls the polarization controller 308 so as to control the measurement light to become circularly polarized. In step S404, the polarization state of the controlled measurement light is determined, and if the measurement light is circularly polarized (OK in step S404), the processing proceeds to step S405; otherwise, the processing returns to step S403. Here, an example of the criteria for determining the circularly polarized light is based on the ellipticity of the measurement light or the signal intensity of the measurement light that has passed through a polarizer.

Thereafter, the polarization controllers 332 and 337 are controlled. The polarization controllers 332 and 337 are controlled by using only the measurement light. In step S405, the driving control unit 349 drives the mirror 314 so that the measurement light is reflected by the mirror 314 and the reflected measurement light returns to the beam splitter 306. Then, in step S406, the shutter 320 is closed so that the reference light is not incident on the beam splitter 330. In step S407, the angle of the galvanoscanner 310 is controlled so that the measurement light is incident on the eye 315 to be examined. Since the light to be incident on the mirror 314 has been controlled to be circularly polarized, the light that returns to the beam splitter 306 becomes linearly polarized. The measurement light that is incident on the beam splitter 306 is emitted to the SM fiber 327 and is incident on the beam splitter 330 via the connector 328 and the SM fiber 329. The light is split by the beam splitter 330 into two components that are in a positive/negative inverted phase relationship. One of the components is incident on the polarization beam splitter 335 via the SM fiber 331, the polarization controller 332, the connector 333, and the SM fiber 334, and the other component is incident on the polarization beam splitter 340 via the SM fiber 336, the polarization controller 337, the connector 338, and the SM fiber 339. Then, the components are each split into two polarization components, namely, the V polarization component and the H polarization component by the respective polarization beam splitters 335 and 340. The V polarization components are guided to the detector 345, and the H polarization components are guided to the detector 346.

In step S408, the signal processing unit 348 determines whether the light is detected only with one of the detectors 345 and 346. If the light is not detected with only one of the detectors 345 and 346 (NG in step S408), in step S409, the driving control unit 349 controls the polarization controllers 332 and 337 so that the light is detected only with one of the detectors 345 and 346. Then, in step S410, as in step S408, the polarization state is determined, and if the determination result is NG, the processing returns to step S409. Meanwhile, if the determination result is OK, the processing proceeds to step S411. Here, an example of the criteria for determining that a signal is detected only with one of the detectors 345 and 346 is based on the ratio between the signal intensities of the two detectors 345 and 346.

Lastly, the polarization controller 318 is controlled. The polarization controller 318 is controlled by using only the reference light signal.

In step S411, the driving control unit 349 drives the galvanoscanner 310 so that the measurement light does not return to the beam splitter 306 and causes the measurement light to be incident on the measurement light detector 316. In step S412, the mirror 314 is removed. Here, although the measurement light is made incident on the measurement light detector 316 in the present exemplary embodiment, the measurement light does not have to be made incident on the measurement light detector 316 as long as the measurement light does not return to the beam splitter 306.

Subsequently, in step S413, the shutter 320 is opened, and the block on the reference light is released. The reference light travels through the SM fiber 317, the polarization controller 318, the collimator 319, the dispersion compensation glass 321, and the ND filter 322, and is reflected by the mirrors 323-a and 323-b disposed on the coherence gate stage 324. The reflected reference light is then incident on the beam splitter 330 via the collimator 325 and the SM fiber 326. The light incident on the beam splitter 330 is guided to the detectors 345 and 346 as described above.

In step S414, the signal processing unit 348 determines whether the signal intensities of the light detected by the respective detectors 345 and 346 are substantially equal to each other. If the signal intensities are not substantially equal to each other (NG in step S414), in step S415, the driving control unit 349 controls the polarization controller 318 so that the signal intensities becomes substantially equal to each other. Then, in step S416, as in step S414, the polarization state is determined, and if the determination result is NG, the processing returns to step S415. Meanwhile, if the determination result is OK, the processing proceeds to step S417. Here, an example of the criteria for determining that the signal intensities of the light detected by the two detectors 345 and 346 are substantially equal to each other is based on the ratio of the signal intensities from the two detectors 345 and 346. The reference light guided to the polarization beam splitters 335 and 340 in the end can be controlled to be linearly polarized light in which the ratio of the V polarization component and the H polarization component is 1:1, or in other words, linearly polarized light that is polarized at an angle of 45° relative to each of the two polarization axes that are orthogonal to each other. Then in step S417, the galvanoscanner 310 is driven so that the measurement light is directed in a direction in which the measurement light is incident on the eye 315 to be examined at the time of the measurement, and the measurement is continued.

According to the configuration and the processing operation described thus far, even in the SS PS-OCT apparatus 300, the polarization state is controlled as appropriate by the polarization controllers provided in the respective optical paths in the interferometer in accordance with the detected polarization states. Therefore, even in a case in which the polarization state changes due to heat produced while the SS PS-OCT apparatus 300 is being used, the polarization state can be corrected.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-034553, filed Feb. 25, 2014, which is hereby incorporated by reference herein in its entirety.

1. A polarization-sensitive OCT apparatus, comprising:
an interference unit configured to split light emitted from a light source into measurement light and reference light and to generate interfered light by causing returning light of the measurement light that has irradiated a subject through a sample arm to interfere with the reference light that has traveled through a reference arm;
a splitting unit configured to split the interfered light into different polarization components;
a generation unit configured to detect the polarization components split by the splitting unit and to generate a signal;
a detection unit configured to detect respective polarization states of the measurement light in the sample arm, the returning light of the measurement light that has passed through the interference unit, and the reference light that has passed through the interference unit; and
polarization control units configured to control the polarization state of the measurement light to a first polarization state, and then to control the polarization states of the returning light of the measurement light and the reference light to a second polarization state different from the first polarization state on the basis of the respective polarization states that have been detected.

2. The polarization-sensitive OCT apparatus according to claim 1,
wherein the detection unit sequentially detects the polarization states of the measurement light, the returning light of the measurement light, and the reference light, and
wherein the polarization control units control the polarization states in the order in which the polarization states are detected.

3. The polarization-sensitive OCT apparatus according to claim 1,
wherein the detection unit that detects the measurement light is disposed so as to be conjugate to the subject.

4. The polarization-sensitive OCT apparatus according to claim 1,
wherein, when the returning light of the measurement light is to be detected, a reflection unit to be disposed on the sample arm is disposed so as to return the returning light of the measurement light to the generation unit, and a blocking unit to be disposed in the reference arm is disposed so as to block the reference light.

5. The polarization-sensitive OCT apparatus according to claim 1,
wherein the interference unit is formed by single-mode fibers, and
wherein the polarization control units are disposed on a sample arm side fiber, a reference arm side fiber, and a detection arm side fiber of the interference unit.

6. The polarization-sensitive OCT apparatus according to claim 1,
wherein the polarization control unit is disposed between the light source and the interference unit.

7. The polarization-sensitive OCT apparatus according to claim 1,
further comprising a polarizer disposed between the polarization control units disposed between the light source and the interference unit and the interference unit.

8. The polarization-sensitive OCT apparatus according to claim 1,
wherein the polarization states are controlled at least when the polarization-sensitive OCT apparatus is started and/or before an image is captured.

9. A method for controlling a polarization-sensitive OCT apparatus that includes an interference unit configured to split light emitted from a light source into measurement light and reference light and to generate interfered light by causing returning light of the measurement light that has irradiated a subject through a sample arm to interfere with the reference light that has traveled through a reference arm, a splitting unit configured to split the interfered light into different polarization components, and a generation unit configured to detect the polarization components split by the splitting unit and to generate a signal, the method comprising:
detecting polarization state of the measurement light in the sample arm, the returning light of the measurement light that has passed through the interference unit, and the reference light that has passed through the interference unit;
controlling the polarization state of the measurement light on the basis of the polarization state that has been detected;
detecting the polarization state of the returning light of the measurement light that has passed through the interference unit or the reference light that has passed through the interference unit; and
controlling the polarization state of the returning light of the measurement light or the reference light on the basis of the polarization state that has been detected.

10. The method according to claim 9,
wherein the detecting of the polarization state includes
detecting the measurement light with a measurement light detection unit,
disposing a reflection unit that reflects light in the sample arm and detecting the returning light of the measurement light with the generation unit in a state in which a blocking unit that blocks light is disposed in the reference arm, and
removing the reflection unit that has been disposed in the sample arm and the blocking unit that has been disposed in the reference arm and detecting the reference light with the generation unit in a state in which the returning light from the sample arm is not present, and
wherein the controlling of the polarization state includes
controlling the detected polarization state of the measurement light to a predetermined polarization state,
controlling the detected polarization state of the returning light of the measurement light to a predetermined polarization state, and
controlling the detected polarization state of the reference light to a predetermined polarization state.

11. A computer-readable recording medium storing a program that causes a computer to implement the method according to claim 9.

12. The polarization-sensitive OCT apparatus according to claim 1, wherein the first polarization state is circularly polarized light, and the second polarization state is linearly polarized light.

13. The polarization-sensitive OCT apparatus according to claim 12, wherein the second polarization state of the reference light is linearly polarized light that is polarized at an angle of 45° relative to each of two polarization axes that are orthogonal to each other.

14. The polarization-sensitive OCT apparatus according to claim 12, wherein the second polarization state of the returning light is linearly polarized light that is polarized at an angle of 0° relative to one of two polarization axes that are orthogonal to each other.

15. The polarization-sensitive OCT apparatus according to claim 1, wherein the detection unit includes a first detection unit which detects the polarization state of the measurement light, and a second detection unit which detects each of the polarization states of the returning light and the reference light.

16. A polarization-sensitive OCT apparatus, comprising:
an interference unit configured to split light from a light source into measurement light and reference light and to generate interfered light by causing the reference light to interfere with returning light of the measurement light that has irradiated a subject;
a splitting unit configured to split the interfered light into first light of first polarization and second light of second polarization;
a detection unit configured to detect the first light and the second light;
a first adjustment unit configured to adjust a polarization state of the measurement light;
a second adjustment unit configured to adjust a polarization state of the returning light that has passed through the interference unit; and
a third adjustment unit configured to adjust a polarization state of the reference light.

17. The polarization-sensitive OCT apparatus according to claim 16,
wherein the first adjustment unit includes
a polarization detection unit configured to detect the polarization state of the measurement light,
a deflection unit configured to irradiate the polarization detection unit with the measurement light, and
an adjustment unit configured to adjust the polarization state of the measurement light detected by the polarization detection unit.

18. The polarization-sensitive OCT apparatus according to claim 16,
wherein the second adjustment unit includes
a blocking unit configured to block the reference light,
a polarization detection unit configured to detect the polarization state of the returning light in a state in which the reference light is blocked by the blocking unit, and
an adjustment unit configured to adjust the polarization state of the returning light detected by the polarization detection unit.

19. The polarization-sensitive OCT apparatus according to claim 16,
wherein the third adjustment unit includes
a blocking unit configured to block the measurement light and/or the returning light,
a polarization detection unit configured to detect the polarization state of the reference light in a state in which the measurement light and/or the returning light is blocked by the blocking unit, and
an adjustment unit configured to adjust the polarization state of the reference light detected by the polarization detection unit.

20. The polarization-sensitive OCT apparatus according to claim 18,
wherein the polarization detection unit is constituted by the interference unit, the splitting unit, and the detection unit, and
wherein the polarization state of the returning light is detected on the basis of an intensity of the first light and an intensity of the second light detected by the detection unit.

21. The polarization-sensitive OCT apparatus according to claim 19,
wherein the polarization detection unit is constituted by the interference unit, the splitting unit, and the detection unit, and
wherein the polarization state of the reference light is detected on the basis of an intensity of the first light and an intensity of the second light detected by the detection unit.
